(19) United States
(12) Patent Application Publication
(10) Pub. No.: US 2011/0214246 A1
(43) Pub. Date: Sep. 8, 2011

(54) Aeroacoustic Duster

(76) Inventors: Jeffrey S. Marshall, Jericho, VT (US); Di Chen, Colchester, VT (US); Nicholas Mario Vachon, Barre, VT (US); Darren Hitt, Jericho, VT (US); Junru Wu, South Burlington, VT (US)

(21) Appl. No.: 13/024,072

(22) Filed: Feb. 9, 2011

Related U.S. Application Data
(60) Provisional application No. 61/303,004, filed on Feb. 10, 2010.

(51) Int. Cl. A47L 5/14; F15D 1/00

(52) U.S. Cl. 15/345

(57) ABSTRACT

The aero-acoustic duster invention disclosed herein provides for high particle removal rate from surfaces with low energy expenditure relative to competing vacuum-based devices. The device removes particulate matter from a surface using a two-step process: 1. Acoustic radiation is used to break the adhesive bonds between dust and the surface, forcing particles into a mode where they continuously bounce up and down on the surface; and, 2. A bounded vortex is generated over the surface, with suction in the vortex center and jets for blowing air along the periphery. The jets are tilted in the tangential direction to induce vortex motion within the suction region. The vortex is said to be bounded because streamlines originating in the downward jets are entrained back into the central vortex.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith.
1. U.S. provisional patent application 61/303,004, entitled “Aeroacoustic Duster”, naming Jeff Marshall, Darren Hitt, Jun-ru Wu, Nick Vachon, and Di Chen as inventors, filed 10 Feb. 2010.

### REFERENCE TO U.S. GOVERNMENT INTEREST

“The U.S. Government has a paid-up license in this invention and the right in limited circumstances to require the patent owner to license others on reasonable terms as provided for by the terms of Grant NNX08AZ07A awarded by NASA.”

### BACKGROUND

1. Field of Use

These teachings relate generally to a system and method for high particle removal rate from surfaces with low energy expenditure. More specifically, these teachings relate to acoustic radiation and a bounded vortex for high particle removal rates.

2. Description of Prior Art (Background)

Conventional vacuum cleaners make a relatively high impact contact with the surface being cleaned. Hence, conventional vacuum cleaners cause considerable surface wear. In addition, conventional vacuum cleaners and brushes have recently been cited as a source of bacteria breeding areas. Therefore, there exists a need for dust mitigation in residential and industrial applications subject to dust build-up, or for applications for optical materials or delicate electronic instrumentation for which contact is undesirable.

### BRIEF SUMMARY

The foregoing and other problems are overcome, and other advantages are realized, in accordance with the presently preferred embodiments of these teachings. The aero-acoustic duster device is intended to provide for high particle removal rate from surfaces with low energy expenditure relative to competing vacuum-based devices. The device removes particulate matter from a surface using a two-step process:
1. Acoustic radiation is used to break the adhesive bonds between dust and the surface, forcing particles into a mode where they continuously bounce up and down on the surface.
2. A bounded vortex is generated over the surface, with suction in the vortex center and jets for blowing air along the periphery. The jets are tilted in the tangential direction to induce vortex motion within the suction region. The vortex is said to be bounded because streamlines originating in the downward jets are entrained back into the central vortex.

By use of acoustic radiation force to levitate dust particles and break their adhesive bonds, the velocity of air flow necessary to remove the particles can be significantly lowered. The vortex acts to enhance shear stress under the suction region, hence increasing the ability of the air flow to entrain particles.

In accordance with one embodiment of the present invention an apparatus for efficiently removing dust particles is provided. The apparatus includes a tweeter for generating acoustic energy and a bounded vortex generator. The bounded vortex generator includes an acoustic emitter for emitting the acoustic energy provided by the tweeter, a plurality of tilted jets for providing tangential air flow across a dusted substrate, and a vacuum port for vacuuming dust excited by the acoustic energy and tangential air flow combination.

The invention is also directed towards a system for removing dust particles. The system includes a tweeter having an acoustic generator for generating sound waves. The acoustic generator includes at least one continuous wave (CW) acoustic generator and at least one frequency modulated (FM) acoustic generator. The system also includes a bounded vortex generator coupled to the tweeter. The tweeter includes an acoustic emitter for emitting acoustic energy; a vacuum port for removing dust; and a plurality of tilted jets surrounding the acoustic emitter for providing a tangential air flow to a surface.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a pictorial illustration of one embodiment of the present non-contact aero-acoustic duster invention;

FIG. 2A is an illustration of a computed flow field generated by bound vortex device in accordance with the invention shown in FIG. 1;

FIG. 2B is an illustration of the computed flow field corresponding vectors in a horizontal plane generated in accordance with the invention shown in FIG. 1;

FIG. 2C is an illustration of the corresponding surface shear stress field in accordance with the invention shown in FIG. 1;

FIG. 3A is a graph of profiles of surface shear stress generated by bounded vortex device in accordance with the invention shown in FIG. 1;

FIG. 3B is a line plot of maximum and average shear stress as function of outlet pressure in accordance with the invention shown in FIG. 1;

FIG. 4A is a schematic diagram of a bounded vortex device in accordance with the invention shown in FIG. 1;

FIG. 4B is a schematic of a set of 12 prototype devices used for testing in accordance with the invention shown in FIG. 1;

FIGS. 5A-5C are schematics of aerodynamic test set-up and results for bounded vortex device using lunar stimulant in accordance with the invention shown in FIG. 1;

FIG. 6 is a block diagram of an experimental configuration for testing particle levitation by acoustic radiation emitted normal to a surface in accordance with the invention shown in FIG. 1;

FIGS. 7A-7D are pictorial illustrations of four reflector surfaces used to validate the performance of the present invention shown in FIG. 1: silicon wafer (FIG. 7A), commercial solar panel(FIG. 7B), synthetic leather (FIG. 7C) and Teflon (FIG. 7D), respectively;

FIGS. 8A-8F are pictorial illustrations of a sequence of particle removal of Mars dust stimulants lodged on a silicon wafer in accordance with the present invention shown in FIG. 1;

FIG. 9A is a pictorial illustration of images of Mars dust stimulants accompanied with the percent-number size-distribution histogram;

FIG. 9B is a pictorial illustration of images of Lunar dust stimulants accompanied by the percent-number size-distribution histogram;

FIG. 10A is a pictorial illustration of images of dust particle removal efficiency accompanied by the percent-number size-distribution histogram for silicon wafer in accordance with the present invention shown in FIG. 1;

FIG. 10B is a pictorial illustration of images of dust particle removal efficiency accompanied by the percent-number size-distribution histogram for solar panel in accordance with the present invention shown in FIG. 1;

FIG. 10C is a pictorial illustration of images of dust particle removal efficiency accompanied by the percent-number size-distribution histogram for synthetic leather in accordance with the present invention shown in FIG. 1;

FIG 10D is a pictorial illustration of images of dust particle removal efficiency accompanied by the percent-number size-distribution histogram for Teflon in accordance with the present invention shown in FIG. 1; and

FIG. 11 is a graph of solar panel voltage output versus time as dust is removed in accordance with the present invention shown in FIG. 1.

### DETAILED DESCRIPTION

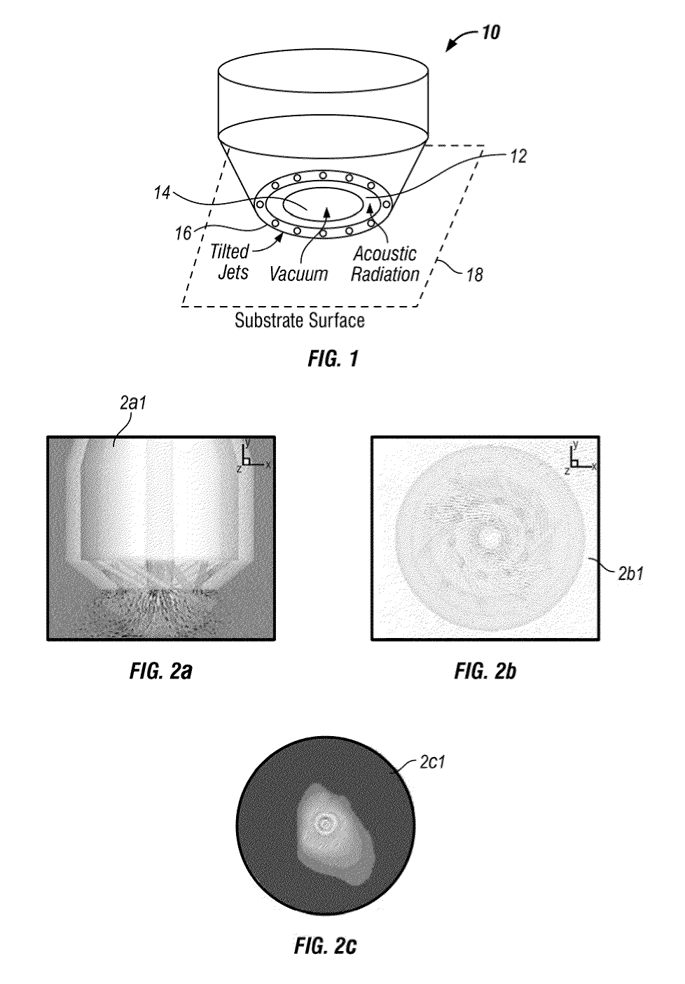

Referring to FIG. 1 there is shown a pictorial illustration of one embodiment of the present non-contact aero-acoustic duster invention. The duster 10 is suspended about 1 cm above a surface 18. The underside of the duster has three active regions: suction port 14; acoustic emitter 12; and tilted jets 16, each of which is of the form of tangential concentric bands or regions as shown in FIG. 1. The centermost region, the suction region 14, leads to a filter similar to that used in traditional vacuum cleaners. The second region, is the acoustic emitter 12 for emitting acoustic radiation at the surface. The third region consists of N tangentially-oriented jets 16, which draw air from the filter exhaust and create a bounded vortex with suction in the center of the suction port 14.

The aero-acoustic duster 10 can be used in the same manner that a vacuum cleaner is used, ranging from small hand-held devices to larger-push-type devices. It may also be incorporated in a mechanical translation device (e.g., arm) to allow for automated cleaning. Unlike conventional vacuum cleaners, the aero-acoustic duster makes no contact with the surface being cleaned. Hence, the aero-acoustic duster 10 does not cause surface wear and is suitable for use on all types of surfaces. The latter fact will make this device particularly useful for dust mitigation in industrial applications subject to dust build-up, or for applications for optical materials or delicate electronic instrumentation for which contact is undesirable.

Vortex Optimization:

The bounded vortex generation device 16 is optimized to provide a strong vortex flow with optimal surface shear stress. Numerical simulations using the computational fluid dynamics software FLUENT to generate the air flow with different number of jets and jet orientations and with different operating pressure differentials.

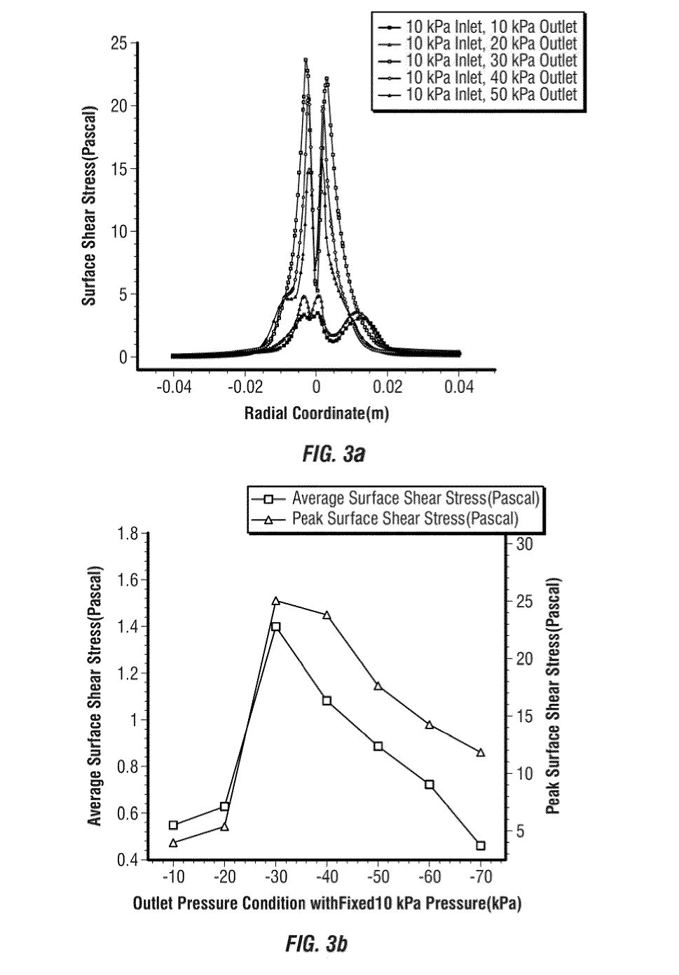

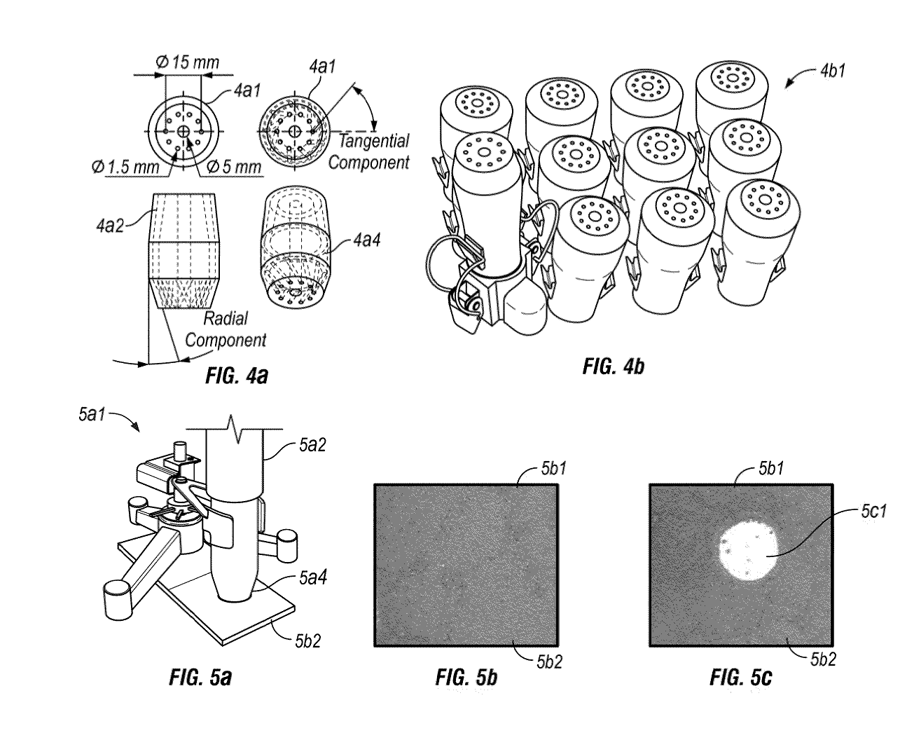

The number of jets and jet tilt angles that provide the maximum shear stress on the substrate surface, which in turn provides the optimal entrainment of particles from the surface, is determined initially from numerical simulations using computational fluid dynamics software. However, it will be appreciated that any suitable number of jets and jet tilt angles that provide the maximum shear stress on the substrate surface, which in turn provides the optimal entrainment of particles from the surface, may be used. Plots of the flow field and substrate surface shear stress at the optimal condition are shown in FIGS. 2A, 2B, and 2C. Referring also to FIG. 3A, there is shown a graph of profiles of surface shear stress generated by bounded vortex device in accordance with the invention shown in FIG. 1. Also referring to FIG. 3B, there is shown a line plot of maximum and average shear stress as function of outlet pressure in accordance with the invention shown in FIG. 1. Twelve prototypes 4b1 of the bounded vortex generators are shown in FIG. 4b, each with different N tangentially-oriented jets 16 (see FIG. 1). Referring also to FIG. 4A there is shown a schematic diagram of a bounded vortex device in accordance with the invention shown in FIG. 1. Still referring to FIG. 4a, vortex lines 4a2 show relative airflow within vortex generator outer shell 4a1. It will be appreciated that the bounded vortex generator outer shell 4a1 may be any suitable material. It will also be appreciated that the internal structure represented by 4a4 may be any suitable internal structure. Finally, it will be understood, that the measurements shown in FIG. 4a are representative and should not be construed as limiting in any manner.

Acoustic Radiation Optimization

Referring also to FIG. 5A there is shown a schematics of aerodynamic test set-up 5a1 for bounded vortex generation device 5a4 and tweeter 5a2. It will be understood that weeter 5a2 may be any suitable acoustic generator. FIG. 5B shows a Plexiglas substrate 5b1 uniformly covered with simulated lunar dust 5b2. FIG. SC shows result for bounded vortex device in accordance with the invention shown in FIG. 1. Still referring to FIG. 5C a weak air cross-flow was introduced to blow the particles off of the Plexiglas substrate 5b1 once the particles are acoustically levitated. The result shows nearly 100% particle removal from the area 5c1 where the particles were subjected to both the acoustic levitation and the air cross-flow.

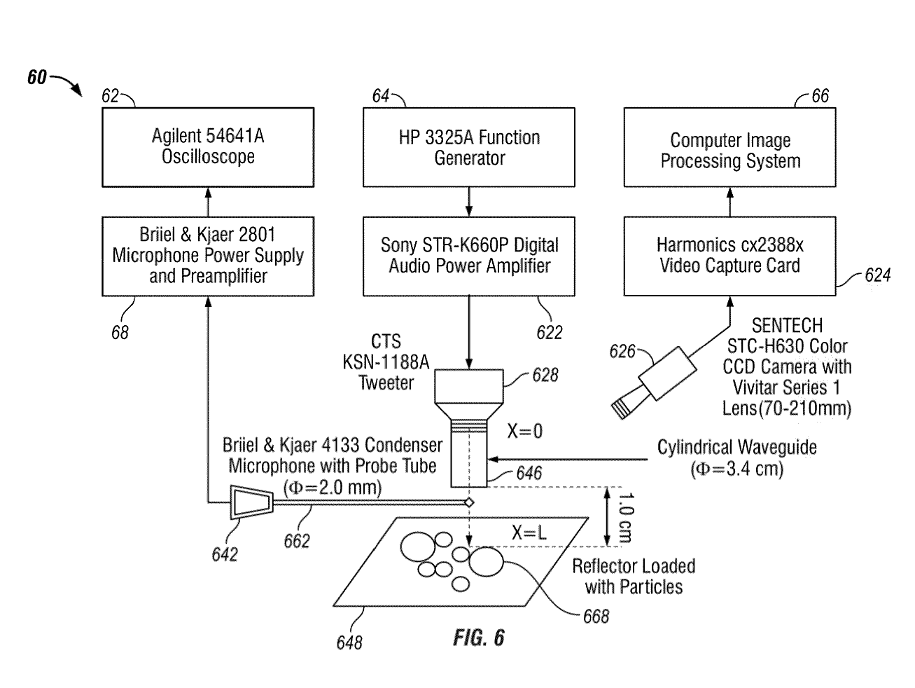

Referring also to FIG. 6 there is shown a block diagram of an experimental configuration for testing particle levitation by acoustic radiation emitted normal to a surface in accordance with the invention shown in FIG. 1. The experimental configuration included an oscilloscope 62, a microphone power supply and pre-amplifier 68, a microphone 642, a probe tube 662, a function generator 64, a audio power amplifier 622, a computer processing imaging system, a video capture card 624, and a CCD camera 626. A weak air cross-flow was introduced to blow the particles 668 off of the test surface 648 once the particles were levitated by tweeter 628 and waveguide 646, respectively. The tests were conducted for both Martian and simulated lunar dust composed of dry particles with diameter ranging from 1-100 □m.

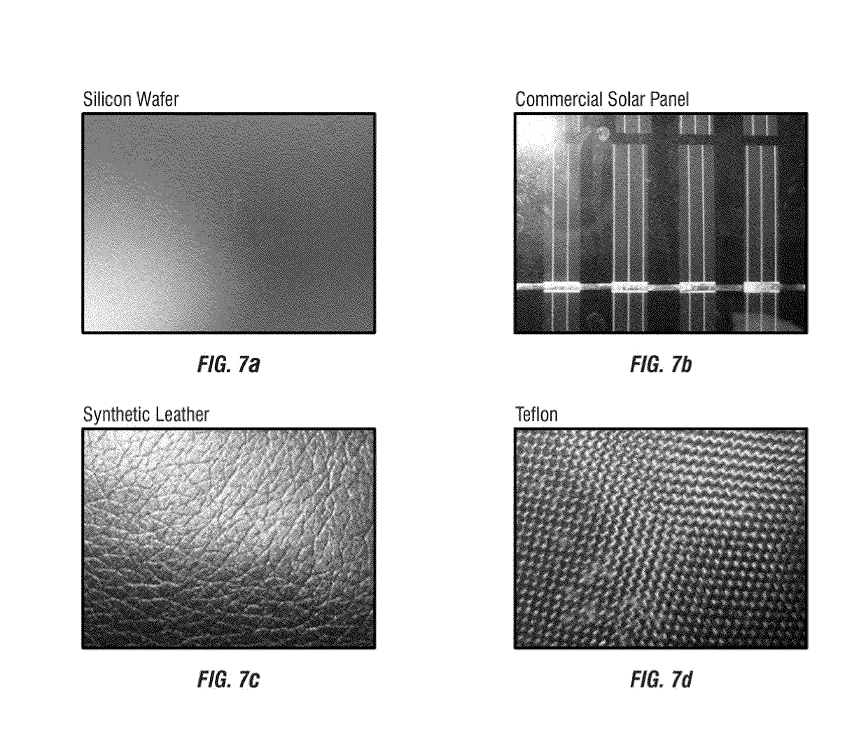

Referring also to FIGS. 7A-7D there are shown pictorial illustrations of four reflector surfaces used to validate the performance of the present invention shown in FIG. 1: silicon wafer (FIG. 7A), commercial solar panel (FIG. 7B), synthetic leather (FIG. 7C) and Teflon (FIG. 7D), respectively. All parameters including L (See FIG. 6), frequency and acoustic intensity were kept the same for all four materials. Each reflector was exposed to the acoustic excitation and air flow for 90 seconds during the removal operation. Size distributions of the residual particles after removal on the reflectors were studied by direct counting.

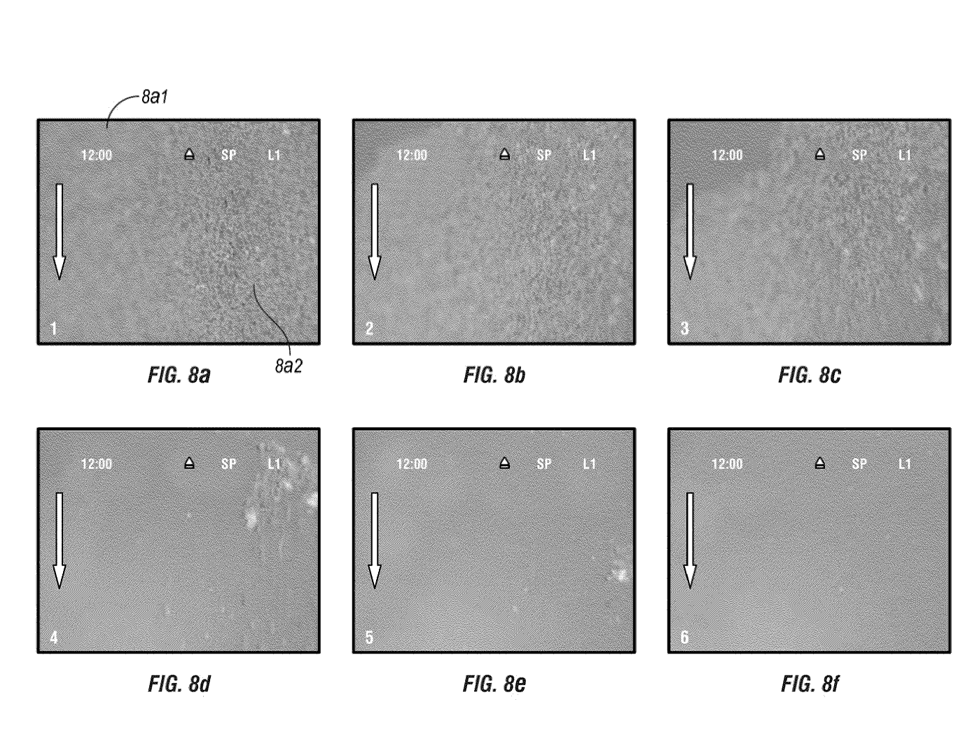

Referring also to FIGS. 8A-8F there are shown pictorial illustrations of a sequence of particle removal of Mars dust stimulants 8a1, 8a2 lodged on a silicon wafer in accordance with the present invention shown in FIG. 1. FIGS. 8A-8F contains 6 images taken in sequence when silicon wafer was chosen as the reflector. The arrow represents the air flow direction. Air flow was continuously on for all 6 images were taken and acoustic signal was continuously turned on starting at images 2, FIG. 8b. There was no particles' movement at the time when image 1, FIG. 8a was taken when only air flow was on. Particles began to be removed as soon as the tweeter (FIG. 6 , item 628) was turned on as shown in images 2-6. It will be appreciated that Mars dust simulants were removed effectively by the air flow after the dust simulants were levitated by the standing wave acoustic field.

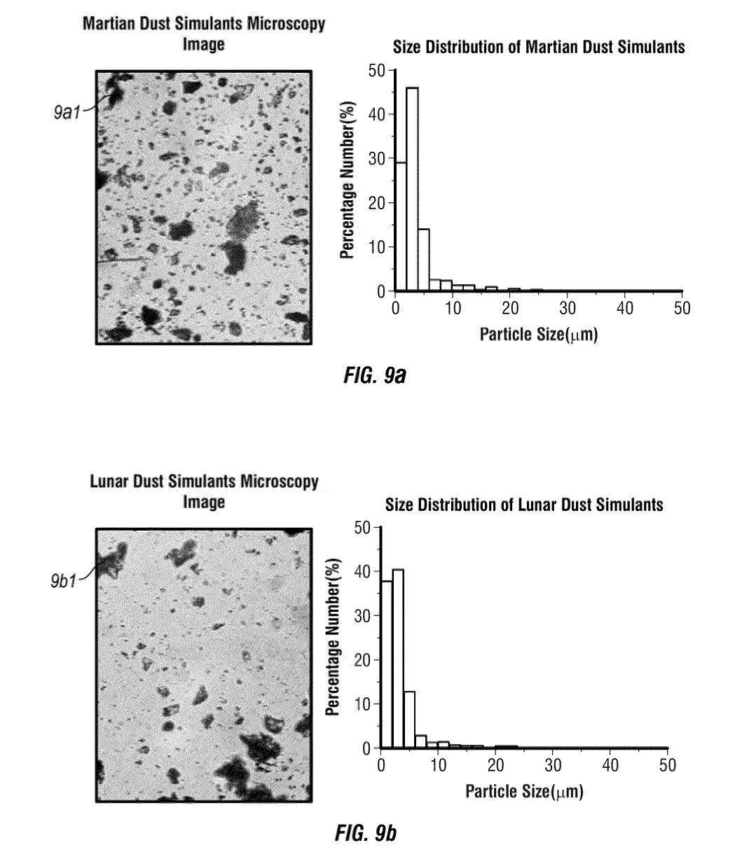

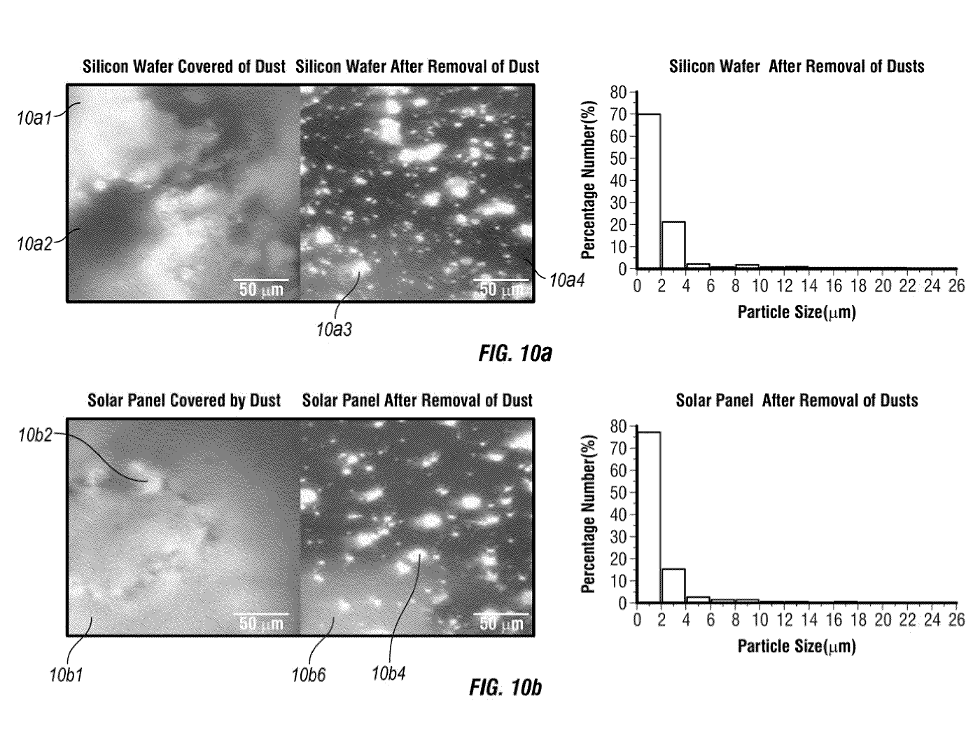

Referring also to FIG. 9A there is shown a pictorial illustration of images of Mars dust stimulants accompanied with the percent-number size-distribution histogram. Likewise, also referring to FIG. 9B is a pictorial illustration of images of Lunar dust stimulants accompanied by the percent-number size-distribution histogram; The histograms of Mars and lunar dust simulants indicate that they both have a large component of particles with diameter less than 6 μm, especially in the 2-4 μm range. The percent-number of Mars dust stimulants for >4 μm is about 25% and that for 2 μm<particle-size<4 μm is about 45%. The lunar dust simulant has a similar percent-number (12% vs 14%) as the Mars dust simulant in the size range >4 μm, a lower percent number (40% vs 45%) in the size range 2 μm-4 μm, and it has more particles in the range <2 μm (38%) than Martian dust simulant has (29%).

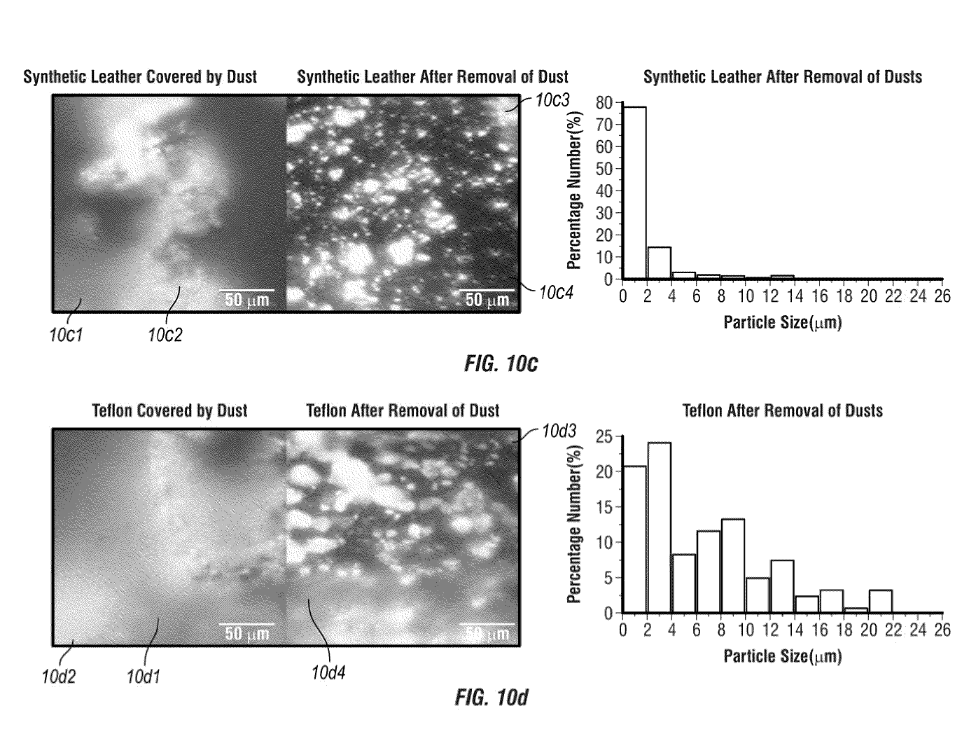

Referring also to FIG. 10A, FIG. 10B, FIG. 10C, and FIG. 10D, there is shown a pictorial illustration of images of dust particle removal efficiency accompanied by the percent-number size-distribution histogram for silicon wafer, solar panel, synthetic leather, and Teflon, respectively, in accordance with the present invention shown in FIG. 1. As shown, there are 3 panels, for each of FIG. 10 A-D; the first two are photos of a reflector covered by Mars dust simulant taken under the microscope before and after the dust-simulants removal operation by air flow and acoustic standing wave, the third panel on the right is the size distribution histogram of the particles residual on the reflector after the removal procedure. Few particles larger than 4 μm were left (from more than 25% before the operation to less than 9% after the operation) on the silicon wafer, solar panel and synthetic leather after the removing operation as shown in FIG. 10 A-C. Particle-number in the range of 2-4 μm was also dramatically reduced from 46% to around 20% on silicon wafer and 15% on the solar-panel and leather surfaces. Small particles whose size was less than 2 μm dominated in the residuals.

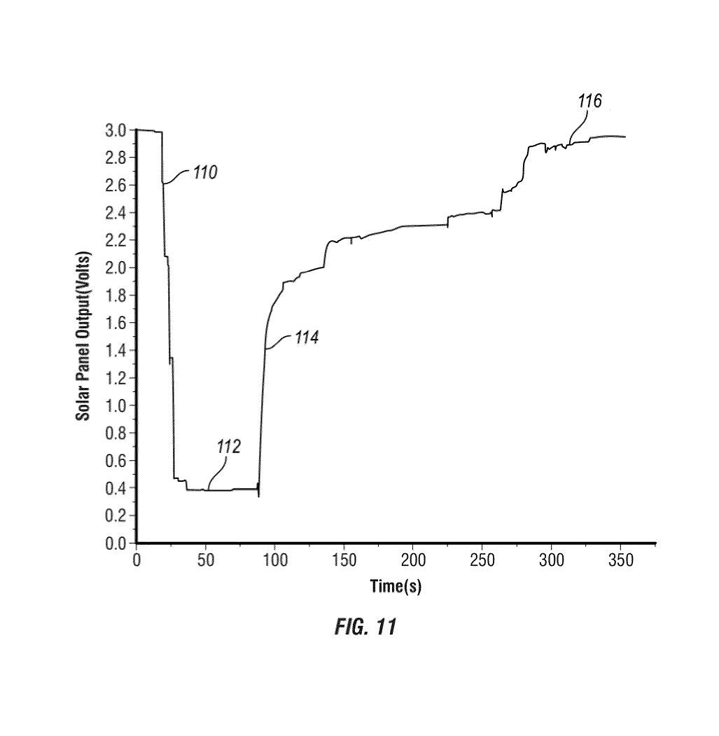

Referring also to FIG. 11 there is shown a graph of solar panel voltage output versus time as dust is removed in accordance with the present invention shown in FIG. 1 The graph reflects the solar panel voltage output changed with time as the Mars dust simulants were sprayed on the surface and gradually removed from it by the combination of acoustic standing wave effect and airflow method. There was a significant drop in solar panel output voltage 110 (below 15% of its initial voltage of 3 V) due to the deposition and coverage of Mars dust simulants. The output voltage remained constant 112 in time until the air flow and acoustic field were applied at t=90 s. The output-voltage of the solar panel restored quickly to 65% of 3 V in first 20 seconds 114, then increased gradually up to 98.4% 116 after 4 minutes

It should be understood that the foregoing description is only illustrative of the invention. For example, tweeter 5a2 shown in FIG. 5a may be one or more suitable acoustic generators for generating continuous wave (CW) acoustic, signals at multiple frequencies and amplitudes, generating frequency modulated (FM) acoustic signals at multiple frequencies and amplitudes, or a combination of CW and FM acoustic signals for specified time intervals. Similarly, bounded vortex generator 5a4 shown in FIG. 5a may include variable air flow generator and adjustable air flow jets. Thus, various alternatives and modifications can be devised by those skilled in the art without departing from the invention. Accordingly, the present invention is intended to embrace all such alternatives, modifications and variances that fall within the scope of the appended claims.

What is claimed is:

1. An apparatus for efficiently removing dust particles, the apparatus comprising:
a tweeter; and
a bounded vortex. generator coupled to the tweeter.

2. The apparatus as in claim 1, wherein the tweeter comprises:
at least one acoustic generator for generating sound waves.

3. The apparatus as in claim 2, wherein the at least one acoustic generator comprises at least one continuous wave (CW) acoustic generator.

4. The apparatus as in claim 3, wherein the at least one CW acoustic generator comprises at least one amplitude variable CW acoustic generator.

5. The apparatus as in claim 2, wherein the at least one acoustic generator comprises at least one frequency modulated (FM) acoustic generator.

6. The apparatus as in claim 5, wherein the at least one FM acoustic generator comprises at least one amplitude variable FM acoustic generator.

7. The apparatus as in claim 1, wherein the bounded vortex generator comprises:
at least one acoustic emitter for emitting acoustic energy;
at least one vacuum port for removing dust; and
a plurality of tilted jets surrounding the acoustic emitter for providing a tangential air flow to a surface.

8. The apparatus as in claim 7, wherein the plurality of tilted jets comprises a plurality of adjustable tilted jets.

9. A system for removing dust particles, wherein the system comprises:
a tweeter comprising:
at least one acoustic generator for generating sound waves, wherein the at least one acoustic generator comprises:
at least one continuous wave (CW) acoustic generator;
at least one frequency modulated (FM) acoustic generator;
a bounded vortex generator coupled to the tweeter, wherein the bounded vortex generator comprises:
at least one acoustic emitter for emitting acoustic energy;
at least one vacuum port for removing dust; and
a plurality of tilted jets surrounding the acoustic emitter for providing a tangential air flow to a surface.

10. A system as in claim 9, wherein the at least one CW acoustic generator comprises at least one amplitude variable CW acoustic generator.

11. A system as in claim 9, wherein the at least one CW acoustic generator comprises at least one amplitude variable FM acoustic generator.

12. A system as in claim 9, wherein the plurality of tilted jets comprise a plurality of adjustable tilted jets.
